(19) United States
(12) Patent Application Publication
(10) Pub. No.: US 2025/0028561 A1
(43) Pub. Date: Jan. 23, 2025

(54) PRE-DEPLOYMENT APPLICATION EVALUATION

(71) Applicant: VMWARE, INC., Palo Alto, CA (US)

(72) Inventors: ISTVÁN IMRE, Budapest (HU); Dènes Nèmeth, Budapest (HU); Akshatha Sathyanarayan, Palo Alto, CA (US); Venu Gopala Rao Kotha, Bangalore (IN); Mohamed Wahab Khan, Madural (IN)

(21) Appl. No.: 18/381,659

(22) Filed: Oct. 19, 2023

(30) Foreign Application Priority Data
Jul. 21, 2023 (IN) 202341049244

(51) Int. Cl. G06F 9/50

(52) U.S. Cl. CPC G06F 9/5027

(57) ABSTRACT

The disclosure provides for pre-deployment evaluation of a plurality of resource definitions of a plurality of resources for deployment, comprising: determining, for each of one or more resource types, one or more attributes of the resource type including a kind of the resource type; determining, for each of the plurality of resources, an associated resource type of the one or more resource types, based on a match between the kind of the associated resource type and a kind of the resource as defined in a corresponding resource definition of the plurality of resource definitions; generating, for each of the plurality of resources, a role-based access control (RBAC) rule based on the one or more attributes of the associated resource type of the resource and the corresponding resource definition of the resource; generating a collection of RBAC rules including the generated RBAC rule for each of the plurality of resources.

### RELATED APPLICATIONS

Benefit is claimed under 35 U.S.C. 119 (a)-(d) to Foreign application No. 202341049244 filed in India entitled “PRE-DEPLOYMENT APPLICATION EVALUATION”, on Jul. 21, 2023, by VMware, Inc., which is herein incorporated in its entirety by reference for all purposes.

Modern applications are applications designed to take advantage of the benefits of modern computing platforms and infrastructure. For example, modern applications can be deployed in one or more data centers, such as in a multi-cloud or hybrid cloud fashion. For example, an application may be deployed in a single cloud or across multiple clouds and thus consume both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods. Containerized workloads run on a container orchestration platform that enables the automation of much of the operational effort required to run containers having workloads and services. This operational effort includes a wide range of things needed to manage a container's lifecycle, including, but not limited to, provisioning, deployment, scaling (up and down), networking, and load balancing.

Kubernetes® (K8S®) software is an example open-source container orchestration platform that automates the deployment and operation of such containerized workloads. In particular, Kubernetes may be used to create a cluster of interconnected nodes, including (1) one or more worker nodes that run the containerized workloads (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

Control plane components include one or more controllers of the control plane. A controller is configured to implement one or more control loops, called controller processes, which watch the state of the cluster and try to modify the current state of the cluster to match an intended state (also referred to as a desired state) of the cluster. For example, an administrator, may describe manifests (also referred to as specifications) of resources such as objects (e.g., pods, deployments, services, replica sets, other Kubernetes resources, etc.) that will run containers in the cluster. The different types of objects may be referred to as different resource types. A single instance of a resource type may be referred to as a resource, and may represent an object. Some resource types are virtual, in that they represent operations on objects, rather than the objects themselves, such as a permission check. These specifications describe the intended state of the resources. In an example, the administrator may define the specifications of resources, such as in one or more YAML files. The administrator may provide the specifications to an application programming interface (API) of the control plane to create the resources and manage the resources to match the intended state.

One type of resource includes custom resources. A custom resource is a resource that extends the API of the control plane or allows a user to introduce their own API into the cluster. For example, a user may generate a custom resource definition (CRD), such as in a YAML file, the CRD defining the building blocks (e.g., structure) of the custom resource. Instances of the custom resource as defined in the CRD can then be deployed in the cluster, such as by using a custom resource specification that describes an intended state of the custom resource.

Creation and management of specifications for resources of one or more clusters can be a difficult and complex task due in part to the number of specifications and resources involved. Accordingly, package managers may be used to create and/or manage the specifications. One popular package manager is Helm. Helm uses a packaging format called charts, referred to as Helm charts. A Helm chart is a collection of files that describe a related set of resources and defines configurations for the resources. Helm charts are created as files laid out in a particular directory tree. They can be packaged into versioned archives to be deployed.

One difficulty with using package managers, such as Helm, to deploy the resources of applications on one or more clusters is that it can be difficult to know which resources may be deployed, access, or modified by the package manger prior to actually deploying the applications. In particular, due to the complexity of the Helm charts, such information is hard to determine manually. Accordingly, installation of an application using a package manager may have unintended security consequences. For example, the application may be configured in a manner that it has access to a secret of another application running in the cluster and is able to send information of the secret outside the cluster, causing a security concern. While namespaces may be used to isolate groups of resources within a cluster, such isolation is weak because many applications require access to global resources that cannot be isolated to a local namespace.

Accordingly, there is a need for a pre-deployment application evaluation system.

### SUMMARY

One or more embodiments provide a method for pre-deployment evaluation of a package comprising a plurality of files comprising a plurality of resource definitions of a plurality of resources for deployment in a container cluster, comprising: receiving a request to evaluate the package; determining, for each of one or more resource types, one or more attributes of the resource type including a kind of the resource type; determining, for each of the plurality of resources, an associated resource type of the one or more resource types, based on a match between the kind of the associated resource type and a kind of the resource as defined in a corresponding resource definition of the plurality of resource definitions; generating, for each of the plurality of resources, a role-based access control (RBAC) rule based on the one or more attributes of the associated resource type of the resource and the corresponding resource definition of the resource; generating a collection of RBAC rules including the generated RBAC rule for each of the plurality of resources.

Further embodiments include one or more non-transitory computer-readable media comprising instructions that, when executed by one or more processors of a computer system, cause the computer system to carry out the above method(s). Further embodiments include a computer system comprising at least one memory and one or more processors configured to carry out the above method(s).

### BRIEF DESCRIPTION OF THE DRAWINGS

FIG. 1A illustrates a computing system in which embodiments described herein may be implemented.

FIG. 1B illustrates an example cluster for running containerized workloads in the computing system of FIG. 1A, according to an example embodiment of the present disclosure.

FIG. 2 shows a call flow diagram depicting a method for pre-deployment evaluation of one or more Helm charts.

FIG. 3 illustrates an example of information regarding a resource type native to a cluster.

FIG. 4 illustrates an example resource definition in a Helm chart.

FIG. 5 illustrates an example Role including a generated rule-based access control (RBAC) rule.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for performing pre-deployment application evaluation are discussed herein. Certain embodiments provide an evaluator configured to take as input 1) one or more Helm charts that describe one or more resources of one or more applications for deployment on one or more clusters; 2) information regarding one or more resources types native to the one or more clusters; and optionally 3) information regarding one or more custom resources (e.g., as defined in CRDs) defined in the one or more Helm charts. The evaluator may be any computing device (e.g., pod, container, virtual machine, physical machine, etc.) configured to run one or more processes to perform techniques discussed herein.

The evaluator is configured to use the input to generate one or more rule-based access control (RBAC) rules that describe the security posture of the one or more resources described in the one or more Helm charts, and add the RBAC rule(s) to a collection of RBAC rules (e.g., a Role or ClusterRole Kubernetes object). For example, an RBAC rule (e.g., as defined in Kubernetes) indicates to which resource types the rule applies, to which resource names the rule applies, to which apiGroups the rule applies, which verbs (e.g., actions, such as get, watch, list, create, etc.) are allowed by the rule, etc.

RBAC is a method of regulating access to computer or network resources based on roles of entities, e.g., users in an organization. In particular, in certain embodiments, an RBAC rule positively defines the verbs that are allowed to be performed by resources matching parameters of the RBAC rule. Kubernetes objects, such as Roles or ClusterRoles may be used to define RBAC rules and can be applied to a cluster. For example, Roles and/or ClusterRoles defining the RBAC rules may be defined in one or more specifications. Roles set permissions within a particular namespace, and one of the parameters of a Role is an indication of the namespace. Accordingly, an RBAC rule defined as part of a Role is limited to providing permissions within the namespace of the Role. CluterRoles can be non-namespaced meaning they can define permissions for resources across a cluster, such as over many (e.g., all) namespaces of a cluster,

Prior to using the Helm chart(s) to deploy the application(s), an administrator may be able to look at the RBAC rules generated by the evaluator to determine the security posture of the one or more resources described in the Helm chart(s), and accordingly determine whether to deploy the application(s) using the Helm chart(s). In some cases, an administrator may modify the RBAC rules to further restrict actions that one or more resources take, such as to address potential security concerns. Accordingly, the administrator may use the Helm chart(s) to deploy the application(s) and further apply the modified RBAC rules to ensure the one or more resources do not present security issues.

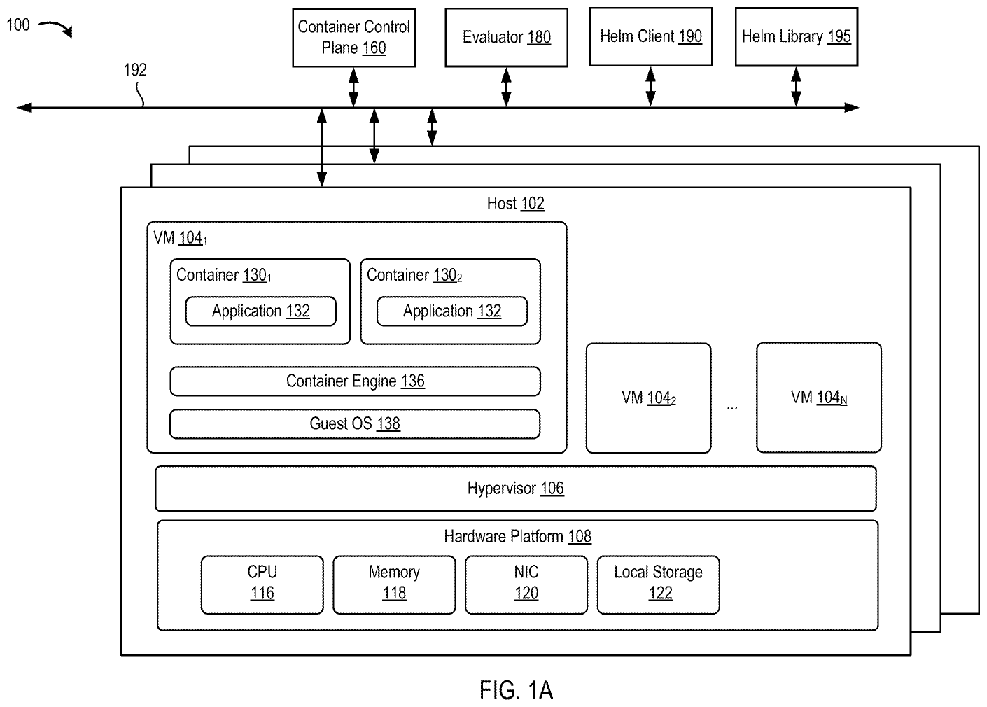

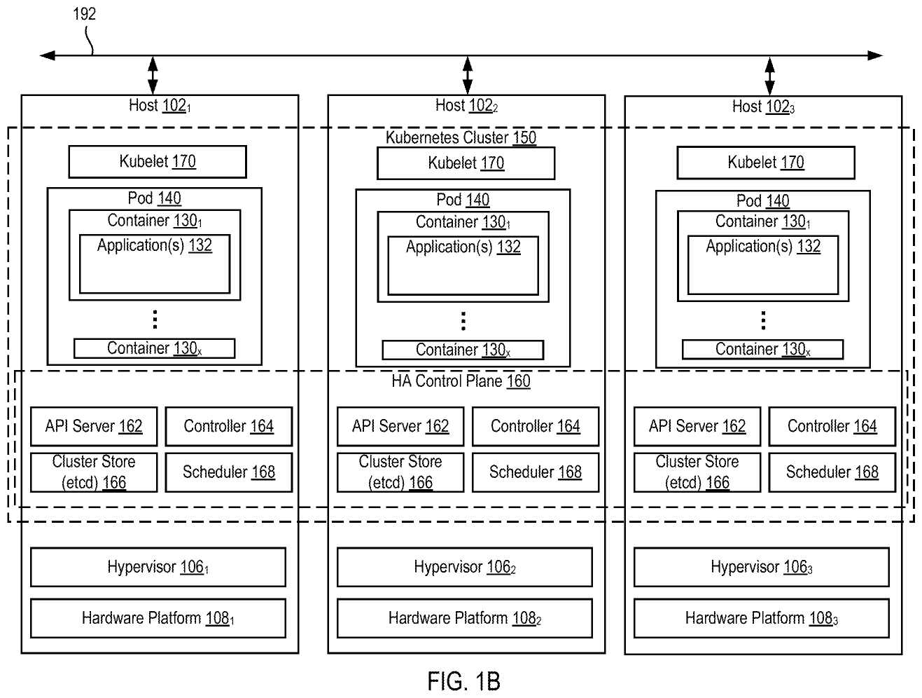

FIG. 1A is a block diagram that illustrates a computing system 100 in which embodiments described herein may be implemented. Computing system 100 includes one or more hosts 102 connected by a physical network 192. In particular, physical network 192 enables communication between hosts 102, and/or between other components and hosts 102. Though not shown, connections between components and hosts 102 may be via one or more additional networks and/or components. Computing system 100 may be a data center.

Hosts 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 1041 to 104x (collectively referred to as VMs 104 and individually referred to as VM 104) that run concurrently on the same host 102.

Hardware platform 108 of each host 102 includes components of a computing device such as one or more processors (central processing units (CPUs)) 116, memory 118, a network interface card including one or more network adapters, also referred to as NICs 120, and/or storage 122. CPU 116 is configured to execute instructions that may be stored in memory 118 and, optionally, in storage 122.

In certain aspects, hypervisor 106 may run in conjunction with an operating system (not shown) in host 102. In some embodiments, hypervisor 106 can be installed as system level software directly on hardware platform 108 of host 102 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 106 implements one or more logical entities, such as logical switches, routers, etc. as one or more virtual entities such as virtual switches, routers, etc. In some implementations, hypervisor 106 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Each VM 104 implements a virtual hardware platform that supports the installation of a guest OS 138 which is capable of executing one or more applications. Guest OS 138 may be a standard, commodity operating system. Examples of a guest OS include Microsoft Windows, Linux, and/or the like.

The virtual hardware platform may include one or more virtual CPUs (VCPUs), a virtual random access memory (VRAM), a virtual network interface adapter (VNIC), and/or virtual host bus adapter (VHBA). For example, hypervisor 106 may be configured to implement the virtual hardware platform of each VM 104 as backed by the hardware platform 108 of host 102.

In certain embodiments, each VM 104 includes a container engine 136 installed therein and running as a guest application under control of guest OS 138. Container engine 136 is a process that enables the deployment and management of virtual instances (referred to interchangeably herein as “containers”) by providing a layer of OS-level virtualization on guest OS 138 within VM 104. Containers 1301 to 130y (collectively referred to as containers 130 and individually referred to as container 130) are software instances that enable virtualization at the OS level. That is, with containerization, the kernel of guest OS 138, or an OS of host 102 if the containers are directly deployed on the OS of host 102, is configured to provide multiple isolated user space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132 as a single executable package of software that bundles application code together with all of the related configuration files, libraries, and dependencies required for it to run. Application 132 may be any software program, such as a word processing program.

In certain embodiments, computing system 100 includes an evaluator 180. Evaluator 180 is a computer program that resides and executes in one or more central servers, which may reside inside or outside the computer system 100, or alternatively, may run in one or more VMs 104, pods, and/or containers on one or more hosts 102 inside or outside the computer system 100. As further described herein, evaluator 180 is configured to generate one or more RBAC rules that describe the security posture of the one or more resources described in one or more Helm charts.

In certain embodiments, computing system 100 includes a Helm client 190. Helm client 190 is a computer program that resides and executes in one or more central servers, which may reside inside or outside the computer system 100, or alternatively, may run in one or more VMs 104, pods, and/or containers on one or more hosts 102 inside or outside the computer system 100. Helm client 190 is configured to provide a command line interface to end users. Helm client 190 is configured to allow for local Helm chart development, manage Helm repositories and releases, and interact with Helm library 195 to execute user commands, such as sending charts to be installed, or requesting upgrading or uninstalling existing releases.

In certain embodiments, computing system 100 includes Helm library 195. Helm library 195 is a computer program that resides and executes in one or more central servers, which may reside inside or outside the computer system 100, or alternatively, may run in one or more VMs 104, pods, and/or containers on one or more hosts 102 inside or outside the computer system 100. Helm library 195 is configured to combine Helm charts and configurations to build a release. Helm library 195 is further configured to install, upgrade, or uninstall Helm charts (and their corresponding resources) with respect to a cluster. Helm library 195 is configured to communicate with an API server 162 (shown in FIG. 1B) of container control plane 160.

In certain embodiments, computing system 100 includes a container control plane 160. Container control plane 160 is a computer program that resides and executes in one or more central servers, which may reside inside or outside the computer system 100, or alternatively, may run in one or more VMs 104 on one or more hosts 102 inside or outside the computer system 100. Container control plane 160 is an orchestration control plane, such as Kubernetes, configured to deploy and manage applications on VMs 104 and/or hosts 102 directly using containers 130. For example, Kubernetes may deploy containerized applications, as containers 130 and a control plane on a cluster of nodes (e.g., hosts 102 and/or VMs 104). Control plane 160 supports the deployment and management of applications on the cluster of nodes using containers 130. In some cases, the control plane 160 deploys applications as pods of containers running on nodes. Though certain aspects are described herein with respect to Kubernetes, including terminology used in Kubernetes, the techniques herein are similarly applicable to other container orchestration platforms.

An example container-based cluster for running containerized applications is illustrated in FIG. 1B. While the example container-based cluster shown in FIG. 1B is a Kubernetes cluster 150, in other examples, the container-based cluster may be another type of container-based cluster based on container technology, such as Docker® clusters.

As illustrated in FIG. 1B, Kubernetes cluster 150 is formed from a combination of one or more pods 140 including one or more containers 130 (e.g., for running applications 132), one or more kubelets 170, and control plane 160. Though components of cluster 150 are shown running directly on hosts 102 for ease of illustration, the components may be running on VMs 104 running on hosts 102. Further, although not illustrated in FIG. 1B, Kubernetes cluster 150 may include one or more kube proxies. A kube proxy is a network proxy that runs on each host 102 in Kubernetes cluster 150 that is used to maintain network rules. These network rules allow for network communication with pods 140 from network sessions inside and/or outside of Kubernetes cluster 150.

Kubelet 170 on each host 102 is an agent that helps to ensure that one or more pods 140 run on each host 102 according to a defined state for the pods 140, such as defined in specification(s) for the pods, such as in a configuration file (e.g., YAML file). Each pod 140 may include one or more containers 130.

Control plane 160 includes components such as an application programming interface (API) server 162, a cluster store (etcd) 166, a controller 164, and a scheduler 168. Control plane 160's components make global decisions about Kubernetes cluster 150 (e.g., scheduling), as well as detect and respond to cluster events (e.g., starting up a new pod 140 when a workload deployment's replicas field is unsatisfied).

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. kube-apiserver is designed to scale horizontally—that is, this component scales by deploying more instances. Several instances of kube-apiserver may be run, and traffic may be balanced between those instances.

Cluster store (etcd) 166 is a data store, such as a consistent and highly-available key value store, used as a backing store for Kubernetes cluster 150 data. In certain aspects, cluster store (etcd) 166 stores one or more specifications of resources, such as in one or more configuration files, that declare intended system infrastructure and application(s) 132 to be deployed in Kubernetes cluster 150. In certain aspects, the manifests are JSON and/or YAML files. In certain aspects, Helm library 195 information is stored in cluster store 166, such as in one or more secrets (e.g., Kubernetes secrets).

Controller 164 is a control plane 160 component that runs and manages controller processes in Kubernetes cluster 150. As described above, control plane 160 may have (e.g., four) control loops called controller processes, which watch the state of Kubernetes cluster 150 and try to modify the current state of Kubernetes cluster 150 to match an intended state of Kubernetes cluster 150, such as defined in the specifications.

Scheduler 168 is a control plane 160 component configured to allocate new pods 140 to hosts 102. Additionally, scheduler 168 may be configured to distribute applications 132, across containers 130, pods 140, VMs 104, and/or hosts 102 that are assigned to use hardware resources of hardware platform 108, such as processor resources, memory resources, networking resources, and/or the like. In some cases, scheduler 168 may schedule newly created containers 130 to one or more VMs 104 of the hosts 102.

In other words, control plane 160 manages and controls every component of Kubernetes cluster 150. Control plane 160 handles most, if not all, operations within Kubernetes cluster 150, and its components define and control Kubernetes cluster 150's configuration and state data. Control plane 160 configures and runs the deployment, management, and maintenance of the containerized applications 132. As such, ensuring high availability of the control plane may be critical to container deployment and management. High availability is a characteristic of a component or system that is capable of operating continuously without failing.

Accordingly, in certain aspects, control plane 160 may operate as a high availability (HA) control plane. Additional details of HA control planes are disclosed in U.S. Application Ser. No. 63/347,815, filed on Jun. 1, 2022, and titled “AUTONOMOUS CLUSTERS IN A VIRTUALIZATION COMPUTING ENVIRONMENT,” which is hereby incorporated by reference herein in its entirety.

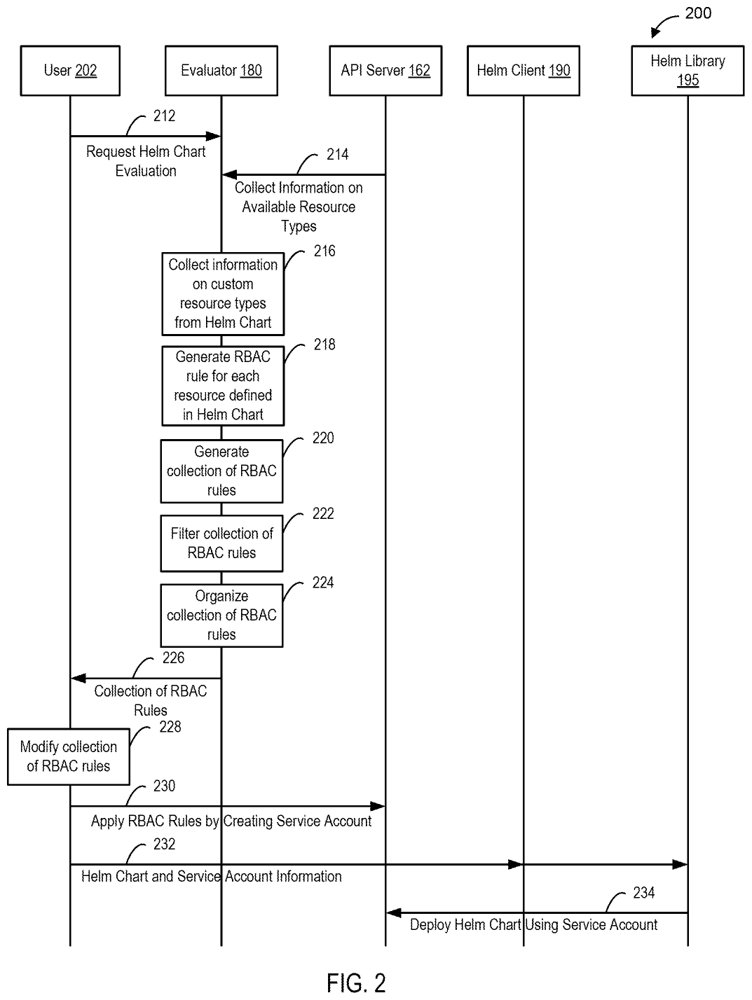

FIG. 2 shows a call flow diagram depicting a method 200 for pre-deployment evaluation of a Helm chart, in accordance with some embodiments. FIG. 2 illustrates components of FIGS. 1A and 1B configured to perform method 200, including Helm client 190, evaluator 180, API server 162, and Helm library 195. Though examples are discussed herein with evaluation of a Helm chart for an application for a cluster, the techniques herein are similarly applicable to evaluation of one or more Helm charts, for one or more applications, to be deployed on one or more clusters. Further, though the techniques are described with respect to Helm charts, it should be noted that the techniques described herein may be similarly applicable to other types of package managers for creating/managing specifications using other types of packages.

At 212, evaluator 180 receives a request to evaluate a Helm chart from a user 202 (e.g., an administrator) for deployment to a cluster (e.g., cluster 150 of FIG. 1B). For example, the request includes the Helm chart.

Continuing, at 214, evaluator 180 collects information on available resource types (e.g., native resource types) for the cluster from API server 162 of the cluster. The information may include a list of names of available resource types (e.g., bindings, componentstatuses, nodes, namespaces, endpoints, pods, podtemplates, secrets, services, etc.). The information may further include, for each resource type, one or more attributes of the resource type. The one or more attributes may include a group of the resource type, a kind of the resource type (often similar to the name), whether the resource type is namespaced (limited to operating within a namespace), verbs associated with the resource type, and/or the like. Verbs associated with the resource type may include an indication of actions that can be performed by the resource type, such as get, put, watch, create, update, etc. For example, evaluator 180 runs a control line command requesting a list of resource types and their attributes from API server 162 for the cluster, such as the control line command kubectl api-resources-o wide. In certain aspects, evaluator 180 collects the information for all resource types available for the cluster. In certain aspects, evaluator 180 collects the information only for resource types included in the Helm chart, such as only for resource types for which a resource of the resource type is defined in the Helm chart for deployment.

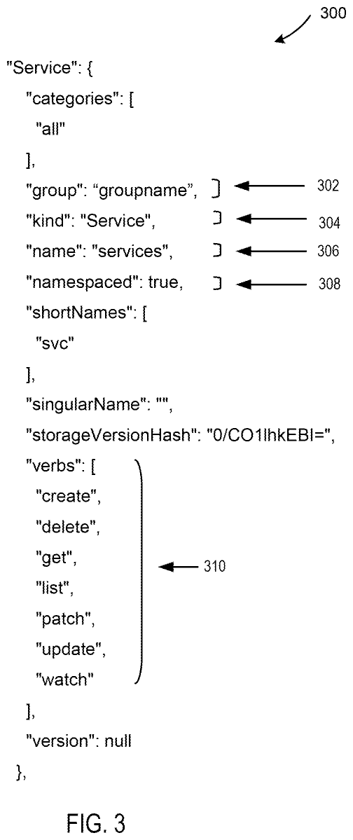

For example, FIG. 3 illustrates an example resource type definition 300, for which the information may be collected at 214. As shown, resource type definition 300 includes a group 302 of the resource type, shown as groupname. Resource type definition 300 further includes a kind 304 of the resource type, shown as Service. Resource type definition 300 also includes a name 306 of the resource type, shown as services. In addition, resource type definition 300 includes an indication 308 of whether the resource type is namespaced, which is shown as true, meaning the resource type is namespaced (as opposed to false when the resource type is not namespaced). Resource type definition 300 also indicates verbs 310 associated with the resource type, shown as create, delete, get, list, patch, update, and watch.

At 216, optionally, evaluator 180 determines any CRDs defined in the Helm chart and processes the CRDs to collect information on custom resource types defined in the Helm chart, similar to 214. For example, evaluator 180 processes the CRDs to extract a list of names of custom resource types and one or more attributes of the custom resource types, similar to 214. For example, though not shown, a CRD may be similar to resource type definition 300, but for a custom resource type.

At 218, evaluator 180 is configured to process the Helm chart to determine each resource defined in the Helm chart for deployment to the cluster and generate an RBAC rule for the resource based on the information about resource types (including custom resource types) collected at 214 and 216. For example, each resource is defined by a resource definition in the Helm chart.

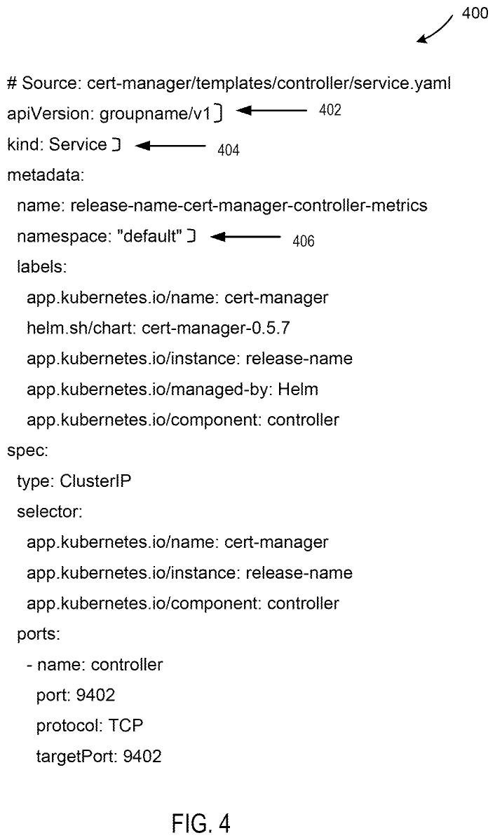

For example, FIG. 4 illustrates an example resource definition 400, which may be included in the Helm chart, and which defines a resource. As shown, the resource definition 400 includes an API version 402 of the resource, shown as groupname/v1. The group of the resource can be extracted from the API version, as the standard format for API version is group/version. Therefore, for API version 402, the group of the resource is groupname. The resource definition 400 further includes a kind 404 of the resource, shown as Service. The resource definition 400 further includes a namespace 406 of the resource, shown as default.

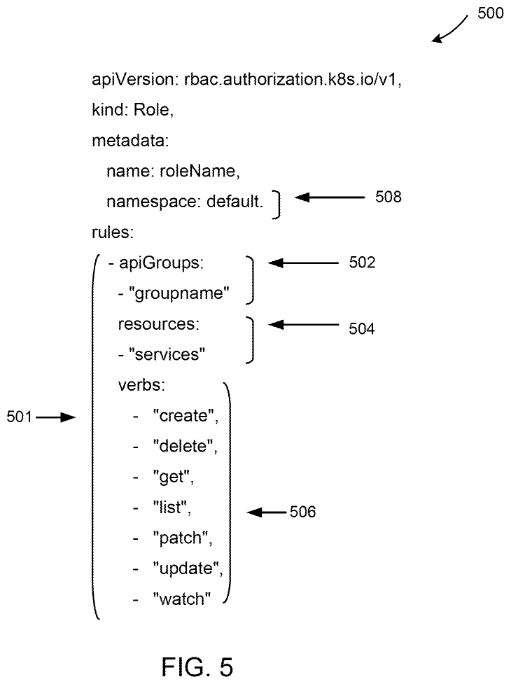

Further, FIG. 5 illustrates an example collection of rules 500 (shown as a Role) including an example RBAC rule 501 generated for the example resource definition 400, based on the resource type definition 300. In particular, to generate RBAC rule 501, evaluator 180 determines the group of the resource defined by resource definition 400, which is extracted from API version 402, as discussed, and is groupname. Further, evaluator 180 determines the kind of the resource defined by resource definition 400, which is determined from kind 404 as Service.

Evaluator 180 then finds, among the resource type information collected at 214 and the custom resource type information collected at 216, a resource type or custom resource type that has a group and a kind that matches the group and kind of the resource defined by resource definition 400. In this example, resource type definition 300 has a group 302 of groupname and a kind 304 of Service, which matches the group and kind of the resource defined by resource definition 400. Accordingly, evaluator 180 uses resource type definition 300 to generate the RBAC rule 501 for resource definition 400.

To generate RBAC rule 501, the evaluator 180 inserts as the apiGroups 502, the group of the resource defined by resource definition 400, which is groupname according to API version 402. Further, the evaluator 180 inserts as the resources 504, the name of the resource type of the resource defined by resource definition 400, which is services according to name 306. In addition, the evaluator 180 inserts as the verbs 506, the verbs of the resource type of the resource defined by resource definition 400, which is create, delete, get, list, patch, update, and watch according to verbs 310. Accordingly, the RBAC rule 501 is generated.

At 220, evaluator 180 generates a collection (e.g., list) of RBAC rules, including the RBAC rules generated at 218. The collection of RBAC rules may be included in one or more specifications (e.g., YAML files) such as defining one or more Kubernetes Roles or Cluster Roles that define the rules. In certain embodiments, RBAC rules that are expressly included in the Helm chart itself are also included in collection of RBAC rules. In certain aspects, RBAC rules for resources of resource types that are namespaced are added to one or more Roles, (e.g., where each role is associated with a given namespace), while RBAC rules for resources of resource types that are not namespaced are added to one or more Cluster Roles. For example, as the resource defined by resource definition 400 is associated with resource type definition 300, and indication 308 of resource type definition 300 indicates the resource type is namespaced (true), the RBAC rule 501 generated for resource definition 400 is added to Role 500. Further, to generate the Role 500, the namespace 508 of the Role (i.e., default) to which the RBAC rule 501 is added is the same as the namespace 406 (i.e., default) in the resource definition 400 of the resource for which RBAC rule 501 is generated. In certain aspects, if other RBAC rules are generated or defined for resources of resource types that are namespaced and the resources are in the same namespace, default, such RBAC rules are also added to Role 500. In certain aspects, if other RBAC rules are generated or defined for resources of resource types that are namespaced and the resources are in a different namespace than default, such RBAC rules may be added to different Role(s). If indication 308 of resource type definition 300 had indicated the resource type is not namespaced (false), the RBAC rule 501 generated for resource definition 400 would have been added to a Cluster Role.

At 222, optionally, evaluator 180 filters the collection of RBAC rules. For example, evaluator 180 removes from the collection of RBAC rules any RBAC rule that provides permissions only in the same namespace (referred to as the target namespace) as which the application deployed by the Helm chart is being deployed. In particular, since a namespace is already the default isolation level for an application, any permissions provided within the namespace of the application will not affect other applications in different namespaces.

At 224, optionally, evaluator 180 is configured to organize the RBAC rules in the collection of RBAC rules. For example, evaluator 180 is configured to merge RBAC rules where possible to reduce the number of RBAC rules. In certain embodiments, if two or more RBAC rules have all the same parameters (e.g., API group(s) to which the rules apply, resource type(s) to which the rules apply, resource name(s) to which the rules apply, verb(s) allowed by the rules, and/or the like) except for one of the parameters, the two RBAC rules may be merged into a single RBAC rule. For example, if two RBAC rule indicate the same API group(s), resource type(s), and resource name(s), but different verb(s), the two RBAC rules can be combined into a single RBAC rule listing the same API group(s), resource type(s), and resource name(s) and a combination of the verbs from the two RBAC rules. The merging of RBAC rules may be performed iteratively, until no more RBAC rules can be merged.

At 226, evaluator 180 sends the collection of RBAC rules to user 202 for review. In particular, as discussed, user 202 can review the RBAC rules to ensure that no resources are provided permissions that indicate a security risk.

At 228, optionally, user 202 modifies one or more RBAC rules of the collection of RBAC rules, such as to add or remove permissions.

At 230, user 202 may apply the collection of RBAC rules to a cluster, such as by creating a service account based on the collection of RBAC rules in the cluster. For example, user 202 may apply the collection of RBAC rules to the cluster by applying one or more specifications including the collection of RBAC rules via API server 162, where the collection of RBAC rules are associated with the service account in the cluster. The service account defines a new account for the API server, and may be associated with a set of information (e.g., credentials), and thus any deployment deployed as associated with the service account will have the collection of RBAC rules applied.

At 232, user 202 deploys the Helm chart by submitting the Helm chart and service account information to Helm library 195 using Helm client 190. At 234, Helm library 195 deploys the Helm chart on the cluster via API server 162 with a configuration (e.g., kubeconfig) utilizing the created service account, thereby applying the collection of RBAC rules to the resources deployed by the Helm chart on the cluster.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more non-transitory computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers”. OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for pre-deployment evaluation of a package comprising a plurality of files comprising a plurality of resource definitions of a plurality of resources for deployment in a container cluster, comprising:
receiving a request to evaluate the package;
determining, for each of one or more resource types, one or more attributes of the resource type including a kind of the resource type;
determining, for each of the plurality of resources, an associated resource type of the one or more resource types, based on a match between the kind of the associated resource type and a kind of the resource as defined in a corresponding resource definition of the plurality of resource definitions;
generating, for each of the plurality of resources, a role-based access control (RBAC) rule based on the one or more attributes of the associated resource type of the resource and the corresponding resource definition of the resource; and
generating a collection of RBAC rules including the generated RBAC rule for each of the plurality of resources.

2. The method of claim 1, wherein the collection of RBAC rules includes a Role including the generated RBAC rule for each of one or more of the plurality of resources that are namespaced in a same namespace.

3. The method of claim 1, wherein the collection of RBAC rules includes a Cluster Role including the generated RBAC rule for each of one or more of the plurality of resources that are not namespaced.

4. The method of claim 1, wherein the one or more attributes of the resource type further include a group of the resource type, and wherein determining the associated resource type is further based on a match between the group of the associated resource type and a group of the resource as defined in the corresponding resource definition.

5. The method of claim 4, wherein generating, for each of the plurality of resources, the RBAC rule comprises:
inserting the group of the resource as defined in the corresponding resource definition;
inserting a name of the resource as defined in the one or more attributes of the associated resource type of the resource; and
inserting one or more verbs of the resource as defined in the one or more attributes of the associated resource type of the resource.

6. The method of claim 1, wherein the package comprises a Helm chart.

7. The method of claim 1, wherein determining, for each of the one or more resource types, the one or more attributes of the resource type comprises querying the container cluster for the one or more attributes.

8. The method of claim 1, wherein determining, for each of the one or more resource types, the one or more attributes of the resource type comprises extracting the one or more attributes for one or more custom resource types from the package.

9. The method of claim 1, wherein the collection of RBAC rules further includes one or more RBAC rules defined in the package.

10. The method of claim 1, wherein generating the collection of RBAC rules comprises merging a first generated RBAC rule for a first resource with a second generated RBAC rule for a second resource.

11. The method of claim 1, further comprising:
applying the collection of RBAC rules to the container cluster; and
deploying the package to the container cluster.

12. A computing system comprising:
one or more memories; and
one or more processors coupled to the one or more memories, the one or more processors configured to cause the computing system to perform operations for pre-deployment evaluation of a package comprising a plurality of files comprising a plurality of resource definitions of a plurality of resources for deployment in a container cluster, the operations comprising:
receiving a request to evaluate the package;
determining, for each of one or more resource types, one or more attributes of the resource type including a kind of the resource type;
determining, for each of the plurality of resources, an associated resource type of the one or more resource types, based on a match between the kind of the associated resource type and a kind of the resource as defined in a corresponding resource definition of the plurality of resource definitions;
generating, for each of the plurality of resources, a role-based access control (RBAC) rule based on the one or more attributes of the associated resource type of the resource and the corresponding resource definition of the resource; and
generating a collection of RBAC rules including the generated RBAC rule for each of the plurality of resources.

13. The computing system of claim 12, wherein the collection of RBAC rules includes a Role including the generated RBAC rule for each of one or more of the plurality of resources that are namespaced in a same namespace.

14. The computing system of claim 12, wherein the collection of RBAC rules includes a Cluster Role including the generated RBAC rule for each of one or more of the plurality of resources that are not namespaced.

15. The computing system of claim 12, wherein the one or more attributes of the resource type further include a group of the resource type, and wherein determining the associated resource type is further based on a match between the group of the associated resource type and a group of the resource as defined in the corresponding resource definition.

16. The computing system of claim 15, wherein generating, for each of the plurality of resources, the RBAC rule comprises:
inserting the group of the resource as defined in the corresponding resource definition;
inserting a name of the resource as defined in the one or more attributes of the associated resource type of the resource; and
inserting one or more verbs of the resource as defined in the one or more attributes of the associated resource type of the resource.

17. The computing system of claim 12, wherein the package comprises a Helm chart.

18. The computing system of claim 12, wherein determining, for each of the one or more resource types, the one or more attributes of the resource type comprises querying the container cluster for the one or more attributes.

19. The computing system of claim 12, wherein determining, for each of the one or more resource types, the one or more attributes of the resource type comprises extracting the one or more attributes for one or more custom resource types from the package.

20. The computing system of claim 12, wherein the collection of RBAC rules further includes one or more RBAC rules defined in the package.

21. The computing system of claim 12, wherein generating the collection of RBAC rules comprises merging a first generated RBAC rule for a first resource with a second generated RBAC rule for a second resource.

22. The computing system of claim 12, the operations further comprising:
applying the collection of RBAC rules to the container cluster; and
deploying the package to the container cluster.

23. One or more non-transitory computer-readable media comprising instructions that, when executed by one or more processors of a computer system, cause the computer system to perform operations comprising:
receiving a request to evaluate the package;
determining, for each of one or more resource types, one or more attributes of the resource type including a kind of the resource type;
determining, for each of the plurality of resources, an associated resource type of the one or more resource types, based on a match between the kind of the associated resource type and a kind of the resource as defined in a corresponding resource definition of the plurality of resource definitions;
generating, for each of the plurality of resources, a role-based access control (RBAC) rule based on the one or more attributes of the associated resource type of the resource and the corresponding resource definition of the resource; and
generating a collection of RBAC rules including the generated RBAC rule for each of the plurality of resources.
